(19) United States
(12) Patent Application Publication
(10) Pub. No.: US 2018/0270159 A1
(43) Pub. Date: Sep. 20, 2018

(54) FLOW CONTROL

(71) Applicant: Hewlett Packard Enterprise Development LP, Houston, TX (US)

(72) Inventors: Xiaoheng SONG, Beijing (CN); Feng WANG, Beijing (CN)

(21) Appl. No.: 15/539,767

(22) PCT Filed: Dec. 18, 2015
(86) PCT No.: PCT/CN2015/097935

§ 371 Date: Jun. 26, 2017

(30) Foreign Application Priority Data
Dec. 19, 2014 (CN) 201410798993.1

(51) Int. Cl. H04L 12/851; H04L 12/721; H04L 12/26; H04L 12/813

(52) U.S. Cl. CPC H04L 47/2483; H04L 45/38; H04L 47/2475; H04L 47/20; H04L 43/0882

(57) ABSTRACT

A software defined network (SDN) forwarding device receives two or more flows; determines a basic Meter table for a flow; determines a union Meter table associated with the basic Meter table; controls the rate of the flow according to first bandwidth indicated by the basic Meter table and second bandwidth indicated by the union Meter table; and forwards the flow according to the controlled rate.

### BACKGROUND

Software Defined Network (SDN) is a new type of network architecture in which a control plane and a forward plane in network equipment can be separated from each other so as to achieve a flexible control for network traffic. The SDN network may comprise a SDN controller and SDN forwarding devices. The SDN controller may distribute a flow table to the SDN forwarding devices, such that the SDN forwarding devices may forward flows according to the flow table. The SDN controller may further distribute a Meter table to the SDN forwarding devices, such that the SDN forwarding devices may monitor and/or regulate flows according to the Meter table. In general, a maximum available bandwidth for transmitting a flow may be defined in the Meter table, and a SDN forwarding device may control the rate of a flow according to the Meter table.

### BRIEF DESCRIPTION OF THE DRAWINGS

FIG. 1 schematically illustrates the architecture of a SDN network according to an example of the present disclosure;

FIG. 2 illustrates a flowchart of a method for flow control according to an example of the present disclosure; and

FIG. 3 schematically illustrates a physical structure of a SDN forwarding device according to an example of the present disclosure.

### DETAILED DESCRIPTION OF THE EMBODIMENTS

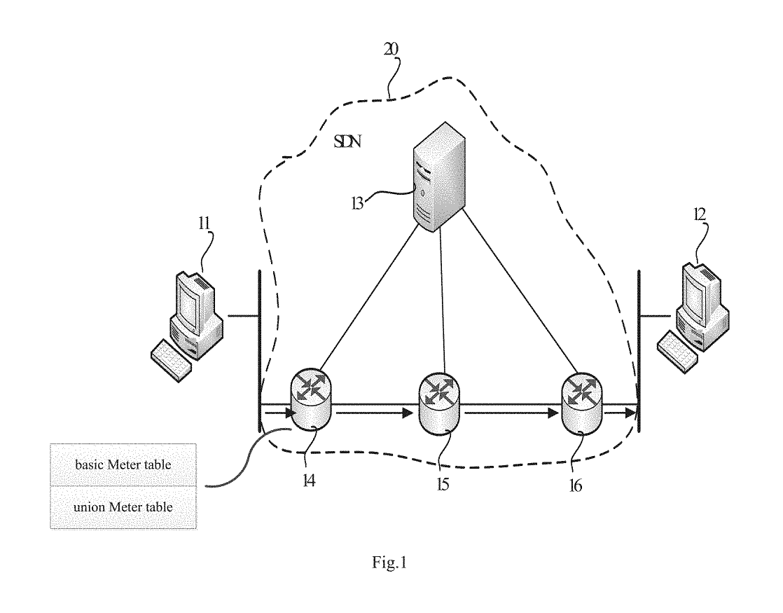

FIG. 1 schematically illustrates the architecture of a SDN network. As illustrated in FIG. 1, a personal computer (PC) 11 may communicate with a PC 12 through a SDN 20. For example, the PC 11 may transmit video flow and audio flow to the PC 12 through the SDN 20. The SDN 20 may comprise a SDN controller 13 and a plurality of SDN forwarding devices. As illustrated in FIG. 1, the SDN 20 includes three SDN forwarding devices, i.e., a SDN forwarding device 14, a SDN forwarding device 15 and a SDN forwarding device 16.

Supposing that data is transmitted from the PC 11 to the PC 12 through a path in the SDN 20 “SDN forwarding device 14→SDN forwarding device 15→SDN forwarding device 16”, the SDN controller 13 may distribute information to the SDN forwarding device 14, the SDN forwarding device 15 and the SDN forwarding device 16 respectively so as to instruct forwarding of the video flow, and the information may include a flow table and a Meter table.

The flow table is configured to instruct a SDN forwarding device to forward a flow. For example, supposing that the flow table shown in Table 1 is distributed to the SDN forwarding device 14 by the SDN controller 13, the SDN forwarding device 14 may be instructed to transmit a video flow of VLAN 100 through a port “A” and transmit an audio flow of VLAN 200 through a port “B”. Besides the above, the SDN controller 13 may designate rules for forwarding other types of flow by distributing the flow table, such as instructing the SDN forwarding device 14 to transmit data of which source or destination addresses are included in some IP address segment through a port “C” (not shown). And in practice, there are other forwarding rules designated for more types of flow, which are not illustrated here.

TABLE 1
Flow table

| VLAN | Egress port | Meter ID (optional) |
|---|---|---|
| 100 | A | 1 |
| 200 | B | 2 |

The meter table is configured to define the available bandwidth for transmitting a flow. In general, a Meter table may include a Meter ID and a Band which indicates the maximum available bandwidth for transmitting a flow. While table 2 is illustrated as a single table, each Meter ID in table 2 actually corresponds to a separate meter table. For example, meter table “1” having Meter ID “1” may be sent to a different SDN forwarding device to meter table “2” having Meter ID “2”. For instance, suppose that the meter table “1” shown in Table 2 is distributed to the SDN forwarding device 14 by the SDN controller 13, the SDN forwarding device 14 is instructed to forward a video flow with a maximum available bandwidth of 200M. Further, suppose that the meter table “2” shown in Table 2 is distributed to the SDN forwarding device 14 by the SDN controller 13, the SDN forwarding device 14 is instructed to forward an audio flow with a maximum available bandwidth of 100M.

TABLE 2
Meter tables

| Meter ID | Band |
|---|---|
| 1 | 200M |
| 2 | 100M |

The SDN controller 13 may also designate a Meter table by the flow table, such that the rate of a flow can be controlled according to the Meter table. For example, as shown in the Table 1, flow control on a video flow of VLAN 100 may be performed according to the Meter table “1”, and flow control on an audio flow of VLAN 200 may be performed according to the Meter table “2”. The Meter tables corresponding to different flows may be distinguished from each other with respective Meter identifiers (IDs). When flow control becomes unnecessary for a flow, the Meter table corresponding to the flow is not used.

As described above, the SUN controller 13 may distribute a flow table and a Meter table corresponding to the flow table. For example, the SDN controller 13 may distribute a flow table in a Flow Modification Message (Flow Mod message) and distribute a Meter table in a Meter Modification Message (Meter Mod message).

With respect to the data transmission path from the PC 11 to the PC 12 “the SDN forwarding device 14→the SDN forwarding device 15→the SDN forwarding device 16” illustrated in FIG. 1, the SDN forwarding device 14 may be regarded as an ingress SDN forwarding device. The ingress SUN forwarding device can receive a flow table and a Meter table distributed from the SDN controller 13, and other SDN forwarding devices in the data transmission path except the ingress SDN forwarding device may receive a flow table distributed from the SDN controller 13, but do not receive a Meter table. That is to say, the SDN forwarding device 14 as an ingress can receive a flow table and a Meter table distributed from the SDN controller 13, so the flow table on the SDN forwarding device 14 may be combined with the Meter table. On the other hand, the SDN forwarding device 15 and the SDN forwarding device 16 will not receive a Meter table distributed from the SDN controller 13, so the flow tables on the SDN forwarding device 15 and the SDN forwarding device 16 will not be combined with a Meter table.

The SDN forwarding device 14 may combine the flow table and the Meter table to generate a Meter forward table for controlling and forwarding a flow. As illustrated in Table 3, a Meter forward table may include one or more forwarding rules as well as bandwidth limit for forwarding a flow.

TABLE 3
Meter forward Table

| VLAN | Egress port | Band |
|---|---|---|
| 100 | A | 200M |
| 200 | B | 100M |

The above Meter tables may specifically limit the rate of a flow by defining the bandwidth available for a flow. According to examples in the present disclosure, there provide two types of Meter tables: a basic Meter table and a union Meter table.

The basic Meter table may instruct the maximum available bandwidth for transmitting an individual flow on a corresponding path, and the maximum available bandwidth for transmitting an individual flow is hereinafter referred to as the first bandwidth for simplicity. For example, the first bandwidth for a video flow is 200M, and the first bandwidth for an audio flow is 100M.

A union Meter table may indicate the maximum available bandwidth for transmitting a union flow. A union flow comprises a plurality of flows on the corresponding path. The maximum available bandwidth for transmitting the union flow is hereinafter referred to as the second bandwidth for simplicity. The second bandwidth indicated in the union Meter table may be smaller than or equal to the maximum bandwidth available for the current path.

For a plurality of flows being transmitted on a path, the SDN controller may configure one or more union Meter tables according to a transmission capacity of the path (such as maximum available bandwidth), further configure respective basic Meter tables for the flows, and further configure which union Meter table is to be associated with a basic Meter table, for example, defining a corresponding relationship between one union Meter table with one or more basic Meter tables.

For example, for a current path with a maximum available bandwidth of 500M, one or more union Meter tables may be configured that the second bandwidths indicated therein are less than or equal to 500M. In an example, a union Meter table 1 may instruct second bandwidth of 500M, and a union Meter table 2 may instruct second bandwidth of 400M. Wherein, the union Meter table 1 may be associated with basic Meter tables for transmitting a flow 1 and a flow 2, and the union Meter table 2 may be associated with basic Meter tables for transmitting a flow 3 and a flow 4. In another example, a union Meter table 3 may instruct second bandwidth of 300M, and a union Meter table 4 may instruct second bandwidth of 200M. And, in case of transmitting a flow 5, a flow 6, a flow 7 and a flow 8 on the path, the union Meter table 3 may be associated with basic Meter tables of the flow 5 and the flow 6, and the union Meter table 4 may be associated with basic Meter tables of the flow 7 and the flow 8.

When a plurality of basic Meter tables are associated with the same union Meter table, second bandwidth instructed by the union Meter table is larger than respective first bandwidths instructed by the basic Meter tables, and smaller than or equal to the sum of the first bandwidths instructed by the basic Meter tables. An individual flow corresponding to one of the basic Meter tables is not only limited by the first bandwidth instructed by the basic Meter table, but also limited by the second bandwidth instructed by the associated union Meter table. For example, supposing that the path “the SDN forwarding device 14→the SDN forwarding device 15→the SDN forwarding device 16” showed in FIG. 1 is used to transmit a video flow and an audio flow, and the maximum available bandwidth for the path is 250M, the SDN controller 13 may configure a union Meter table instructing second bandwidth of 250M, as well as two basic Meter tables which are associated with the union Meter table and respectively instruct first bandwidth of 200M for a video flow and first bandwidth of 100M for an audio flow. In this case, the union Meter table instructing second bandwidth of 250M may limit the rate of a union flow within 250M, wherein the union flow includes the video flow and the audio flow.

For a basic Meter table associated with a union Meter table, the basic Meter table may include a Meter ID of the associated union Meter table.

Referring to Table 4, it shows a Meter table according to an example in the present disclosure. In contrast to the Meter table in Table 2, the Meter table showed in Table 4 further includes a type of Meter table and Meter ID of associated Meter table. The type of Meter table in the Table 4 represents whether the Meter table is a basic Meter table or union Meter table, the Meter ID of associated Meter table represents which union Meter table is associated with a basic Meter table. For a union Meter table, the Meter ID of associated Meter table may be NULL so as to indicate it associates with no other union Meter table. And, even for a basic Meter table, the Meter ID of associated Meter table may also be not provided.

TABLE 4
Meter table

| | | | Meter ID of associated |
|---|---|---|---|
| Meter ID | band | type of Meter table | Meter table |
| 1 | 200M | Basic | Meter 3 |
| 2 | 100M | Basic | Meter 3 |
| 3 | 400M | Union | Null |

A Meter table (basic Meter table or union Meter table) may be distributed by the SDN controller to a SDN forwarding device using a Meter Mod message, and part of the content of the Meter Mod message is listed below:

```
  struct ofp_meter_mod {
  struct ofp_header header;
  uint16_t command; /* One of OFPMC_*. */
  uint16_t flags; /* Bitmap of OFPMF_* flags. */
  uint32_t meter_id; /* Meter instance. */
  uint16_t type;/* meter type, basic or union */
  uint32_t associated_id;/* associated meter id, not associated with an
invalid meter id */
  struct ofp_meter_band_header bands[0]; /* The band list length is
inferred from the length field in the header. */
  }
```

Referring to the bold letters in the above, “uint16_t type” represents the type of Meter table, indicating whether it is a basic Meter table or a union Meter table. For example, 00 represents a basic Meter table as first type of Meter table, and 01 represents a union Meter table as second type of Meter table.

The “uint32_t associated_id” represents the Meter ID of associated Meter table. When the “uint16_t type” indicates that the meter table is a basic Meter table, the “uint32_t associated_id” represents a Meter ID of an associated union Meter table. If the “uint16_t type” represents that the Meter table is a union meter table, then the “uint32_t associated_id” may be set as an invalid value (for example, 11 indicates an invalid value), which means that the union Meter table associates with no union meter table. If the “uint16_t type” represents that this Meter table is a basic table but this basic Meter table associates with no Meter table, then the “uint32_t associated_id” may also be set as an invalid value. In a word, if a basic Meter table includes a Meter ID of associated Meter table, the SDN controller may determine the associated Meter table as a union Meter table associated with the basic Meter table.

After receiving the above Meter table distributed from the SDN controller, the SDN forwarding device may combine the flow table and the Meter table to generate a Meter forward table for controlling rate of a flow and then forwarding the flow according to the controlled rate. The generated Meter forward table is similar to the Meter forward table of Table 3 and they both include forwarding rule and first bandwidth of each of the flows, but the generated Meter forward table may further include second bandwidth defined by the associated union Meter table.

Based on the Meter forward table, the SDN forwarding device may perform flow control on the flow for forwarding. For example, the SDN forwarding device may control the rate of a video flow to be within 200M and the rate of an audio flow to be within 100M according to first bandwidths indicated in corresponding basic Meter tables, and may control the rate of a union flow of the two types of traffics to be within 250M according to second bandwidth defined by an associated union Meter table. When either rate of the video flow and the audio flow exceeds the corresponding first bandwidth or the rate of the union flow consisting of the video flow and the audio flow exceeds the second bandwidth, the SDN forwarding device may perform flow regulation according to a preset rule, such as abandoning part of packets. When the abandoning is performed, the abandoned part may be determined according to some specific parameters, such as a priority of the traffic. For example, if the video traffic is given a relatively higher priority than the audio traffic on the SDN forwarding device, the packets of the video traffic may be abandoned less than the audio traffic.

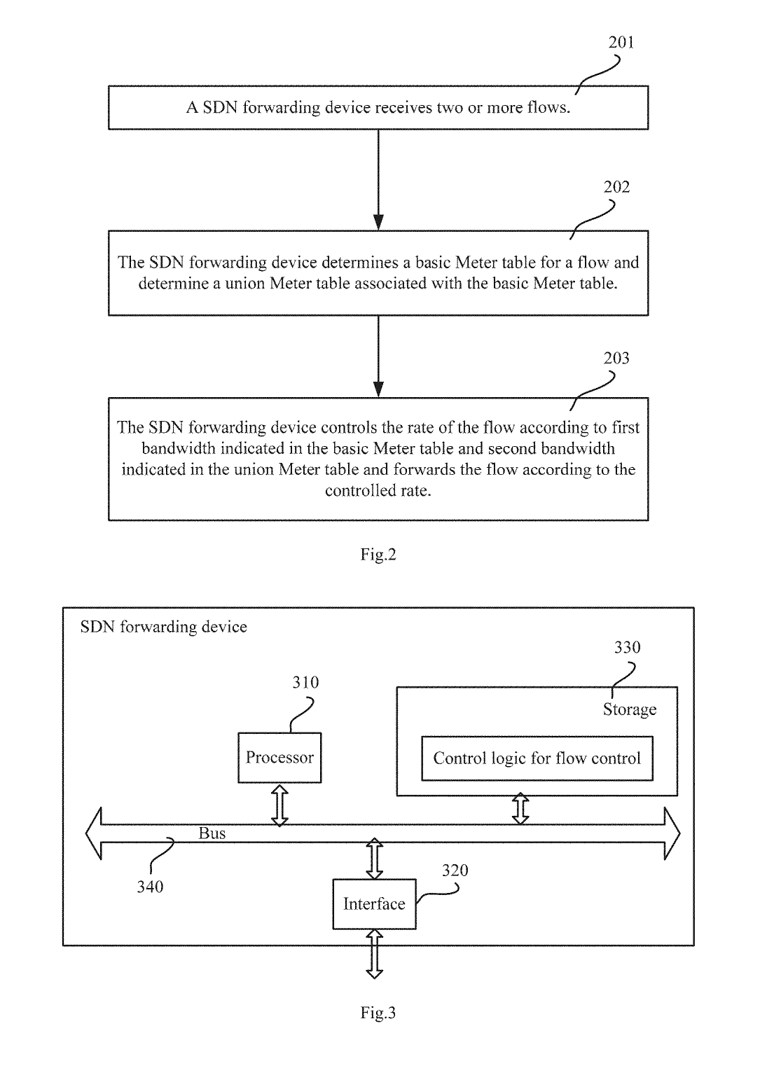

FIG. 2 is an example of a method for flow control performed by a SDN forwarding device. The SDN forwarding device may for example be a device for forwarding data in a SDN network. As illustrated in FIG. 2, the method may include blocks 201-203.

In block 201, the SDN forwarding device may receive two or more flows. In one example, the flows may be a video flow and an audio flow. The received flows may share a same transmission path.

In block 202, the SDN forwarding device may determine a basic Meter table for a flow and determine a union Meter table associated with the basic Meter table. By ‘determine’ it is meant that the forwarding device determines to use a particular basic Meter table and a union Meter table associated with the basic Meter table as the basis for performing flow control on the flow.

In this block, the forwarding device determines which Meter table will be used to control a flow by the SDN forwarding device. For example, for each of the flows, the SDN forwarding device may acquire a corresponding basic Meter table distributed from the SDN controller. And a union Meter table associated with the basic Meter table may also be distributed from the SDN controller and acquired by the SDN forwarding device. For example, a basic Meter table may contain a Meter ID of a union Meter table associated with the basic Meter table.

In block 203, the SDN forwarding device may control the rate of the flow according to a first bandwidth indicated by the basic Meter table and a second bandwidth indicated by the union Meter table, and forward the flow according to the controlled rate.

For example, when controlling the flows, the SDN forwarding device may control the rate of an individual flow according to first bandwidth indicated by a basic Meter table corresponding to the individual flow, and may control the rate of the union flow consisting of a plurality of flows according to second bandwidth instructed by a union Meter table associated with the plurality of flows. Controlling a flow according to a bandwidth means to control the flow such that its rate of flow does not exceed the bandwidth. Thus a controlled flow may have a rate below this bandwidth, but not above this bandwidth. This is described as a controlled rate of flow. In this context a ‘controlled rate’ of flow does not indicate a specific rate of flow but rather that the rate of flow does not exceed a limit specified by the bandwidth.

By use of basic Meter tables and a union Meter table, the SDN forwarding device may perform flow control on individual flows according to respective basic Meter table and perform flow control on a union flow according to the union Meter table.

According to another example of the present disclosure, the union Meter table may indicate flow control mode for controlling the union flow, such as first flow control mode or second flow control mode.

In the example, the SDN controller may add the flow control mode into the union Meter table distributed by a Meter Mod message, and part of the content in the Meter Mod message is illustrated as follows:

```
  struct ofp_meter_mod {
  struct ofp_header header;
  uint16_t command; /* One of OFPMC_*. */
  uint16_t flags; /* Bitmap of OFPMF_* flags. */
  uint32_t meter_id; /* Meter instance. */
  uint16_t type;/* meter type, basic or union */
  uint16_t mode;/* meter mode, strict or loose, only valid for union type */
  uint32_t associated_id;/* associated meter id, not associated with an invalid meter id */
  struct ofp_meter_band_header bands[0]; /* The band list length is inferred from the length
field in the header. */
  };
```

The “uint16_t mode” added in the Meter table may represent a flow control mode. For example, the flow control mode may be “strict” or “loose”, wherein, the strict represents a strict control mode referred to as first flow control mode, and the loose represents a loose control mode referred to as second flow control mode.

Further, the flow control mode may be taken as an attribute of the union Meter table, and a basic Meter table may not have such an attribute or the value of such attribute may be invalid. For example, when the Meter table is a basic Meter table, the “uint16_t type” and “uint32_t associated_id” defined in the Meter table may have a valid value, but the “uint16_t mode” may have an invalid value. When the Meter table is a union Meter table, the “uint16_t type” and “uint16_t mode” (strict or loose) defined in the Meter table may have a valid value, while the “uint32_t associated_id” of the union Meter table may have an invalid value.

After receiving Meter tables from the SDN controller, the SUN forwarding device may determine which basic Meter table associates a union Meter table in order to determine two or more basic Meter tables associated with the same union Meter table, and further determine a union flow consisting of flows corresponding to the two or more basic Meter tables. Additionally, the SDN forwarding device may acquire a flow control mode in the same union Meter table such as “uint16_t mode” mentioned in the above. If the rate of the union flow is within second bandwidth indicated in the same union Meter table, the SUN forwarding device may control the rate of the flow corresponding to each of the two or more basic Meter tables, according to a flow control mode indicated by the same union Meter table and the first bandwidth.

If the flow control mode is the first flow control mode “strict”, the rate of the flow corresponding to each of the two or more basic Meter tables may be compared with its first bandwidth. When the rate of the flow exceeds its first bandwidth, the rate of the flow may be controlled according to a predetermined policy. And when the rate of the flow is within its corresponding first bandwidth, the flow may be forwarded.

For example, a basic Meter table of video traffic defines first bandwidth of 200M, a basic Meter table of audio traffic defines first bandwidth of 100M, and a union Meter table corresponding to a union flow consisting of the video traffic and the audio traffic defines second bandwidth of 250M. In this case, if the flow control mode of the union Meter table is the first flow control mode “strict”, the SDN forwarding device may compare the rate of each of the video flow and the audio flow with its corresponding first bandwidth when it is determined that the rate of the union flow consisting of the video traffic and the audio traffic is less than 250M. And as results of the comparison, when the rate of one of the video flow and the audio flow exceeds the corresponding first bandwidth, the flow will be controlled according to a predetermined policy such as abandoning more packets, and when within the corresponding first bandwidth, the flow will be forwarded. Thus, the rate of an individual flow or a union flow consisting of the individual flows will not exceed corresponding maximum available bandwidth.

If the flow control mode of the union Meter table is the second flow control mode “loose”, the SDN forwarding device may compare the rate of an individual flow corresponding to any one of the basic Meter tables with the corresponding first bandwidth when it is determined that the rate of the union flow consisting of the video traffic and the audio traffic is less than 250M. And as results of the comparison, if the rate of an individual flow exceeds its first bandwidth, the individual flow may be allocated a remaining bandwidth and forwarded accordingly, wherein the remaining bandwidth equals to the second bandwidth minus the rate of the union flow. Otherwise, if the rate of an individual flow is within its first bandwidth, the individual flow may be forwarded. For example, supposing that the rate of the audio flow is only 10M without exceeding its corresponding first bandwidth 100M, and the rate of the video flow is 210M with exceeding its corresponding first bandwidth 200M, but the rate of the union flow consisting of the audio flow and the video flow is only 220M and less than the second bandwidth 250M, the SDN forwarding device may allocate the remaining bandwidth 30M (the second bandwidth 250M−the union flow 220M) to the video flow such that the video flow of 210M can be transmitted totally by a bandwidth of 230M (its first bandwidth 200M+the remaining bandwidth 30M). Thus, on premise that the rate of the union flow does not exceed its corresponding maximum available bandwidth, the remaining bandwidth may be allocated to the flow of which the rate exceeds its corresponding maximum available bandwidth, so that the utilization of bandwidth may be effectively increased.

No matter whether the flow control mode is the first flow control mode or the second flow control mode, once the rate of the union flow exceeds the second bandwidth defined by the union Meter table, the SDN forwarding device may limit the union flow according to a predetermined policy, such as abandoning part of the packets. When the abandoning is performed, the part to be abandoned may be determined according to various factors such as respective priorities of the flows. For example, if the video flow may be given a higher priority than the audio flow on the SDN forwarding device, the packets of the video flow may be abandoned less than the audio flow.

In the above example, it describes a case that the rate of only one of the video flow and the audio flow exceeds its corresponding first bandwidth. While in another case that the rates of two or more flows among a plurality of flows exceed respective first bandwidths defined by corresponding basic Meter tables, the remaining bandwidth equal to the second bandwidth minus the rate of the union flow may be allocated to the flows exceeding their corresponding first bandwidths according to a specific allocating policy. And the allocating policy may be flexible and vary depending on actual service demands. For example, the remaining bandwidth may be totally allocated to a flow with the highest priority, or each of the flows exceeding respective first bandwidths may share the remaining bandwidth commonly (for example, the remaining bandwidth may be evenly or unevenly allocated to the flows exceeding respective first bandwidths), etc.

The SDN controller may change the attribute “uint16_t mode” of a union Meter table. For example, supposing the “uint16_t mode” in an original union Meter table distributed by the SDN controller is strict, if the SDN controller wants to change the “uint16_t mode” into loose, the SDN controller may generate an updated union Meter table in which the “uint16_t mode” is set as loose, and then the updated union Meter table may be distributed through a Meter Mod message. After receiving the updated union Meter table, the SDN forwarding device may substitute the original union Meter table with the updated one and thus the “uint16_t mode” is updated to loose.

By use of basic Meter tables and a union Meter table, the SDN forwarding device may perform flow control on individual flows or the union flow thereof according to these Meter tables. Furthermore, by setting a flow control mode of the union Meter table, the flow controlling may be more flexible, and thus the utilization of the bandwidth can be effectively increased.

FIG. 3 illustrates a physical structure of a SDN forwarding device including a processor 310, a communication interface 320, a non-transitory storage medium 330 and a bus 340, wherein, the processor 310, the communication interface 320 and the non-transitory storage medium 330 communicate with each other through the bus 340.

The communication interface 320 can communicate with network elements, such as receiving messages from a SDN controller or communicating with other SDN forwarding devices. The processor 310 may be a Central Processing Unit (CPU). The non-transitory storage medium 330 may be a non-transitory memory which stores machine readable instructions corresponding to control logic for flow control. The method for flow control performed by the SDN forwarding device can be achieved by the processor 310 to: receive two or more flows; determine a basic Meter table for a flow; determine a union Meter table associated with the basic Meter table; control the rate of the flow according to first bandwidth indicated by the basic Meter table and second bandwidth indicated by the union Meter table; and forward the flow according to the controlled rate, which can be seen from the flowchart in FIG. 2.

If the above functions are achieved in the form of software functional modules, a machine readable storage medium storing a program which includes the software functional modules can be used as an independent product or for sale. It can be understood that the technical solution of the present disclosure can be partly or totally achieved in the form of software product including a plurality of machine readable instructions, the software product may be stored in a storage medium, and a processing device (such as a personal computer (PC), a server, or a network device, etc.) reads out the software product to perform part or all of the blocks of the method in the examples of the present disclosure. And the above-mentioned storage medium may include: USB flash disk, removable hard disk, read-only memory (ROM), random access memory (RAM), magnetic disk or optic disk and other types of storage medium storing program code.

The foregoing examples are merely illustrative but not intended to limit the disclosure, and any modifications, equivalent substitutions, or adaptations, thereof shall be encompassed in the claimed scope of the appended claims without departing from the spirit and scope of the disclosure.

1. A method for flow control, the method includes:
receiving, by a software defined network (SDN) forwarding device, two or more flows;
determining, by the SDN forwarding device, a basic Meter table for a flow;
determining, by the SUN forwarding device, a union Meter table associated with the basic Meter table;
controlling, by the SDN forwarding device, the rate of the flow according to a first bandwidth indicated by the basic Meter table and a second bandwidth indicated by the union Meter table; and
forwarding, by the SDN forwarding device, the controlled flow.

2. The method according to claim 1, wherein, determining the union Meter table associated with the basic Meter table includes:
if the basic Meter table includes an identifier of an associated Meter table,
determining, by the SDN forwarding device, the associated Meter table as the union Me table associated with the basic Meter table.

3. The method according to claim 1, wherein, controlling the rate of the flow according to a first bandwidth indicated by the basic Meter table and a second bandwidth indicated by the union Meter table includes:
determining, by the SDN forwarding device, two or more basic Meter tables associated with the same union Meter table;
determining, by the SDN forwarding device, a union flow, wherein the union flow consists of flows corresponding to the two or more basic Meter tables; and
if the rate of the union flow is within the second bandwidth indicated by the same union Meter table, controlling, by the SDN forwarding device, the rate of the flow corresponding to each of the two or more basic Meter tables, according to a flow control mode indicated by the same union Meter table and the first bandwidth.

4. The method according to claim 3, wherein, in a case that the flow control mode is first flow control mode, controlling the rate of the flow corresponding to each of the two or more basic Meter tables includes:
comparing, by the SDN forwarding device, the rate of the flow with the first bandwidth; and
if the rate of the flow exceeds the first bandwidth, limiting, by the SDN forwarding device, the rate of the flow according to a predetermined policy; and
if the rate of the flow is within the first bandwidth, forwarding, by the SDN forwarding device, the flow.

5. The method according to claim 3, wherein, in a case that the flow control mode is second flow control mode, controlling the rate of the flow corresponding to each of the two or more basic Meter tables includes:
comparing, by the SDN forwarding device, the rate of the flow with the first bandwidth; and
if the rate of the flow exceeds the first bandwidth, allocating, by the SDN forwarding device, a remaining bandwidth to the flow, wherein the remaining bandwidth is equal to the second bandwidth minus the rate of the union flow; and
if the rate of the flow is within the first bandwidth, forwarding, by the SDN forwarding device, the flow.

6. The method according to claim 3, wherein, controlling the rate of the flow according to first bandwidth indicated by the basic Meter tables and second bandwidth indicated by the union Meter table further includes:
if the rate of the union flow exceeds the second bandwidth, limiting, by the SDN forwarding device, the rate of the union flow according to a predetermined policy.

7. A software defined network (SDN) forwarding device, including a processor and a non-transitory storage medium storing machine readable instructions which are executable by the processor to:
receive two or more flows;
determine a basic Meter table for a flow;
determine a union Meter table associated with the basic Meter table;
control the rate of the flow according to a first bandwidth indicated by the basic Meter table and a second bandwidth indicated by the union Meter table; and
forward the flow according to the controlled rate.

8. The SDN forwarding device according to claim 7, wherein, when determining the union Meter table, by executing the machine readable instructions, the processor is further caused to:
if the basic Meter table includes an identifier of an associated Meter table,
determine the associated Meter table as the union Meter table associated with the basic Meter table.

9. The SDN forwarding device according to claim 7, wherein, by executing the machine readable instructions, the processor is further caused to:
determine two or more basic Meter tables associated with a same union Meter table;
determine a union flow, wherein the union flow consists of flows corresponding to the two or more basic Meter tables; and
if the rate of the union flow is within the second bandwidth indicated by the same union Meter table, control the rate of the flow corresponding to each of the two or more basic Meter tables, according to a flow control mode indicated by the same union Meter table and the first bandwidth.

10. The SDN forwarding device according to claim 9, wherein, in a case that the flow control mode is first flow control mode, by executing the machine readable instructions, the processor is further caused to:
compare the bandwidth of the flow with the first bandwidth; and
if the bandwidth of the flow exceeds the first bandwidth, limit the bandwidth of the flow according to a predetermined policy; and
if the bandwidth of the flow is within the first bandwidth, forward the flow.

11. The SDN forwarding device according to claim 9, wherein, in a case that the flow control mode is second flow control mode, by executing the machine readable instructions, the processor is further caused to:
compare the rate of the flow with the first bandwidth; and
if the rate of the flow exceeds the first bandwidth, allocate a remaining bandwidth to the flow, wherein the remaining bandwidth is equal to the second bandwidth minus the rate of the union flow; and
if the rate of the flow is within the first bandwidth, forward the flow.

12. The SDN forwarding device according to claim 9, wherein, by executing the machine readable instructions, the processor is further caused to:
if the rate of the union flow exceeds the second bandwidth, control the rate of the union flow according to a predetermined policy.
